(19) United States
(12) Patent Application Publication
(10) Pub. No.: US 2015/0130358 A1
(43) Pub. Date: May 14, 2015

(54) LED CONTROLLING DEVICE

(71) Applicant: SAMSUNG ELECTRO-MECHANICS CO., LTD., Suwon-Si (KR)

(72) Inventor: Ju Rae KIM, Suwon-Si (KR)

(21) Appl. No.: 14/316,683

(22) Filed: Jun. 26, 2014

(30) Foreign Application Priority Data
Nov. 11, 2013 (KR) 10-2013-0136558

(51) Int. Cl. H05B 33/08; H05B 37/02

(52) U.S. Cl. CPC H05B 33/0815; H05B 37/0227; H05B 37/0218; H05B 37/0272
USPC 315/159; 315/149; 315/200 R; 315/308

(57) ABSTRACT

A light emitting diode (LED) controlling device may include: a driving circuit unit converting input power into an output voltage and providing the output voltage to an LED module; a detecting circuit unit positioned between the driving circuit unit and the LED module and detecting the output voltage and an output current of the LED module; and a controlling circuit unit converting an external signal into a reference signal and comparing the reference signal with at least one of the output voltage and the output current to control an output of the LED module. The external signal may be one of a first signal provided by a sensor module, a second signal provided by a communications module, and a third signal provided by an output control module.

### CROSS-REFERENCE TO RELATED APPLICATION

This application claims the benefit of Korean Patent Application No. 10-2013-0136558 filed on Nov. 11, 2013, with the Korean Intellectual Property Office, the disclosure of which is incorporated herein by reference.

### BACKGROUND

The present disclosure relates to a light emitting diode (LED) controlling device.

Recently, in accordance with the development of semiconductor technology, an output of a light emitting diode (LED), a light source manufactured using a semiconductor, has increased. Therefore, research into a technology of replacing illumination lamps such as existing incandescent lamps, fluorescent lamps, and the like, with lamps using LEDs as light sources has been actively conducted. In some technology fields, LEDs have are already in use as new light sources, substituting for existing lamps.

Currently, the use of LEDs has gradually increased in order to save energy otherwise consumed in traditional illumination schemes and for environmental benefits. In addition, LEDs may be variously controlled beyond a simple turn-on/off function of traditional lighting sources, according to the related art, due to advantages such as ease of control, or the like. Further, LED illumination is supplied at a time in which LED illumination is required at a location at which the LED illumination is required, such that an energy saving effect may be significantly increased as compared with the traditional illumination schemes according to the related art and user convenience may be significantly increased.

However, in the traditional illumination schemes, according to the related art, light sources are various, and control methods for respective traditional illumination scheme light sources are significantly different from each other. In addition, since various illumination control schemes are present, a separate device is required in order to comprehensively manage various illumination control schemes, causing increases in the number of required components and costs.

The following Related Art Document (Patent Document 1), related to a dimming device of a sensor lamp using an LED, discloses a technology of preventing unnecessary power consumption by combining an illuminance sensor and a human body sensor with an LED. However, Patent Document 1 does not disclose a device capable of controlling LEDs using a single power source by integrating a sensor module, a communications module, and an LED output control module in a single device, unlike the present disclosure.

### RELATED ART DOCUMENT

(Patent Document 1) Korean Patent Laid-Open Publication No. 10-2011-0027337

### SUMMARY

An aspect of the present disclosure may provide alight emitting diode (LED) controlling device allowing for more convenient and effective control of an LED module by integrating a sensor module, a communications module, and an LED output control module in a single device.

According to an aspect of the present disclosure, an LED control device may include: a driving circuit unit converting input power into an output voltage and providing the output voltage to an LED module; a detecting circuit unit positioned between the driving circuit unit and the LED module and detecting the output voltage and an output current of the LED module; and a controlling circuit unit converting an external signal into a reference signal and comparing the reference signal with at least one of the output voltage and the output current to control an output of the LED module, wherein the external signal is one of a first signal provided by a sensor module, a second signal provided by a communications module, and a third signal provided by an output control module.

The LED control device may further include a rectifying unit rectifying the input power and providing the rectified power to the driving circuit unit.

The driving circuit unit may include: a power factor compensating circuit unit controlling a power factor of the input power; a converter unit including a switching element, converting a voltage level of the input power provided by the power factor compensating circuit, and providing the input power of which the voltage level is converted to be appropriate for the LED module; and a control module controlling a switching operation of the switching element of the converter unit.

The controlling circuit unit may include: a signal input unit receiving the external signal; a signal converting unit converting the external signal provided by the signal input unit into the reference signal; a comparing circuit unit comparing the reference signal with at least one of the output voltage and the output current; and a light amount controlling unit controlling the output of the LED module depending on a comparison result of the comparing circuit unit.

The controlling circuit unit may further include an impedance converting unit adjusting impedance between the signal input unit and the signal converting unit.

The sensor module may include: an illuminance sensor sensing external illuminance; an operation sensor sensing an external operation; and a sensor controlling unit generating the first signal using sensed data provided by at least one of the illuminance sensor and the operation sensor and providing the first signal to the controlling circuit unit.

The communications module may include: a Wi-Fi module transmitting and receiving data to and from the outside using Wi-Fi communications; a Bluetooth module transmitting and receiving data to and from the outside using Bluetooth communications; a Zigbee module transmitting and receiving data to and from the outside using Zigbee communications; and a communications controlling unit generating the second signal using the data provided by at least one of the Wi-Fi module, the Bluetooth module, and the Zigbee module and providing the second signal to the controlling circuit unit.

The output control module may generate the third signal for controlling the switching operation of the switching element and provide the third signal to the controlling circuit unit, the third signal being a pulse width modulation (PWM) signal.

The controlling circuit unit may put the driving circuit unit into a standby mode in the case in which a voltage level of the reference signal is a preset voltage or less.

According to another aspect of the present disclosure, an LED control device may include: a driving circuit unit including a transformer, generating an output voltage from input power, and providing the output voltage to an LED module; a detecting circuit unit positioned on a secondary side of the transformer and detecting the output voltage and an output current of the LED module; a reference signal generating unit receiving an external signal and generating a reference signal; a comparing circuit unit comparing the reference signal with at least one of the output voltage and the output current; and a light amount controlling unit controlling an output of the LED module depending on a comparison result of the comparing circuit unit.

The LED control device may further include a rectifying unit positioned on a primary side of the transformer, rectifying the input power, and providing the rectified power to the driving circuit unit.

The driving circuit unit may include: a power factor compensating circuit unit positioned on a primary side of the transformer and controlling a power factor of the input power; a control module controlling a switching operation of a switching element included in the primary side of the transformer; and a converter unit converting a voltage level of the input power provided by the power factor compensating circuit unit and supplying the input power of which the voltage level is converted to be appropriate for the LED module.

The LED control device may further include an external signal generating unit generating the external signal using at least one of a sensor module, a communications module, and an output control module, wherein the sensor module includes a plurality of sensors and a sensing controlling unit generating a first signal using sensed data provided by the plurality of sensors, the communications module includes a plurality of communications devices and a communications controlling unit generating a second signal using communications data provided by the plurality of communications devices, the output control module generates a third signal for controlling a switching operation of a switching element included in a primary side of the transformer depending on the output current provided by the detecting circuit unit, and the external signal is one of the first to third signal.

The third signal may be a PWM signal.

The plurality of sensors may include at least one of an illuminance sensor sensing external illuminance and providing illuminance data to the sensing controlling unit, a heat sensor sensing external heat and providing heat data to the sensing controlling unit, and an operation sensor sensing an external operation and providing operation data to the sensing controlling unit.

The plurality of communications devices may include at least one of a Wi-Fi module providing data received from the outside using Wi-Fi communications to the communications controlling unit, a Bluetooth module providing data received from the outside to the communications controlling unit using Bluetooth communications, and a Zigbee module providing data received from the outside to the communications controlling unit using Zigbee communications.

The reference signal generating unit may adjust impedance between the external signal generating unit and the light amount controlling unit.

The light amount controlling unit may put the driving circuit unit into a standby mode in the case in which a voltage level of the reference signal is a preset voltage or less, as the comparison result of the comparing circuit unit.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram showing a light emitting diode (LED) controlling device according to an exemplary embodiment of the present disclosure;

FIG. 2 is a block diagram showing an example of a driving circuit unit shown in FIG. 1;

FIG. 3 is a block diagram showing an example of a controlling circuit unit shown in FIG. 1;

FIG. 4 is a block diagram showing an example of a sensor module shown in FIG. 1;

FIG. 5 is a block diagram showing an example of a communications module shown in FIG. 1;

FIG. 6 is a block diagram showing the LED control device of FIG. 1 in more detail;

FIG. 7 is a block diagram showing an LED control device according to another exemplary embodiment of the present disclosure;

FIG. 8 is a block diagram showing an example of an external signal generating unit shown in FIG. 7; and

FIG. 9 is a block diagram showing the LED control device of FIG. 7 in more detail.

### DETAILED DESCRIPTION

Exemplary embodiments of the present disclosure will now be described in detail with reference to the accompanying drawings. The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Throughout the drawings, the same reference numerals will be used throughout to designate the same or like elements.

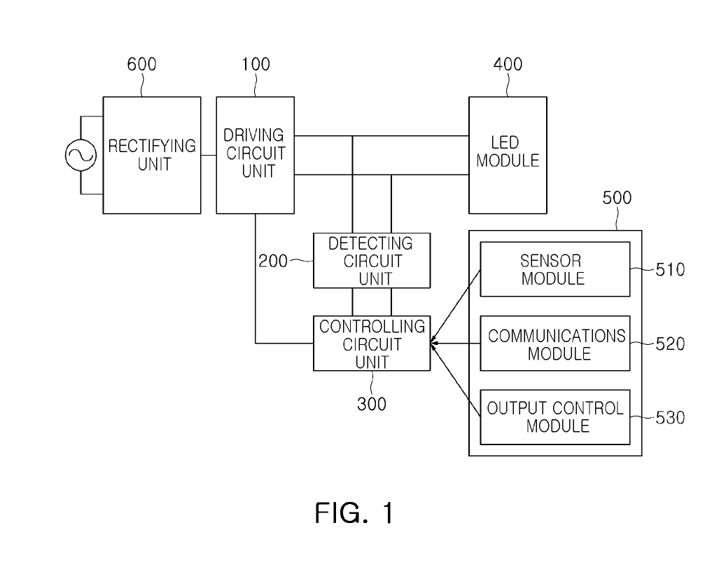

FIG. 1 is a block diagram showing a light emitting diode (LED) controlling device according to an exemplary embodiment of the present disclosure.

Referring to FIG. 1, an LED control device according to an exemplary embodiment of the present disclosure may include a driving circuit unit 100, a detecting circuit unit 200, and a controlling circuit unit 300. In addition, the LED control device according to an exemplary embodiment of the present disclosure may further include a sensor module 510, a communications module 520, and an output control module 530.

The driving circuit unit 100 may receive input power, convert the input power into an output voltage, and provide the output voltage to an LED module 400. Here, the input power may be alternating current (AC) power.

The detecting circuit unit 200 may be positioned between the driving circuit unit 100 and the LED module 400. In addition, the detecting circuit unit 200 may detect the output voltage provided by the driving circuit unit 100 to the LED module 400 and an output current of the LED module 400.

The controlling circuit unit 300 may convert a provided external signal into a reference signal. In addition, the controlling circuit unit 300 may compare the converted reference signal into one of the output voltage and the output current to control an output of the LED module 400.

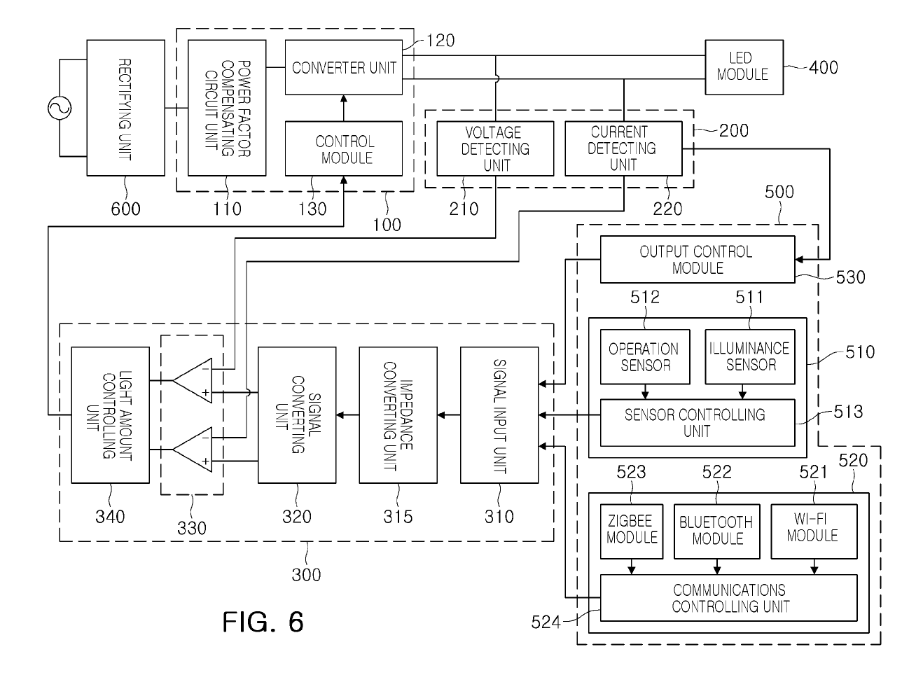

Here, the controlling circuit unit 300 may receive the external signal from one of the sensor module 510 generating a first signal, the communications module 520 generating a second signal, and the output control module 530 generating a third signal. That is, the external signal may be any one of the first to third signals. This will be described below in detail with reference to FIG. 6.

Meanwhile, the LED control device according to an exemplary embodiment of the present disclosure may further include a rectifying unit 600 rectifying the input power and providing the rectified power to the driving circuit unit 100.

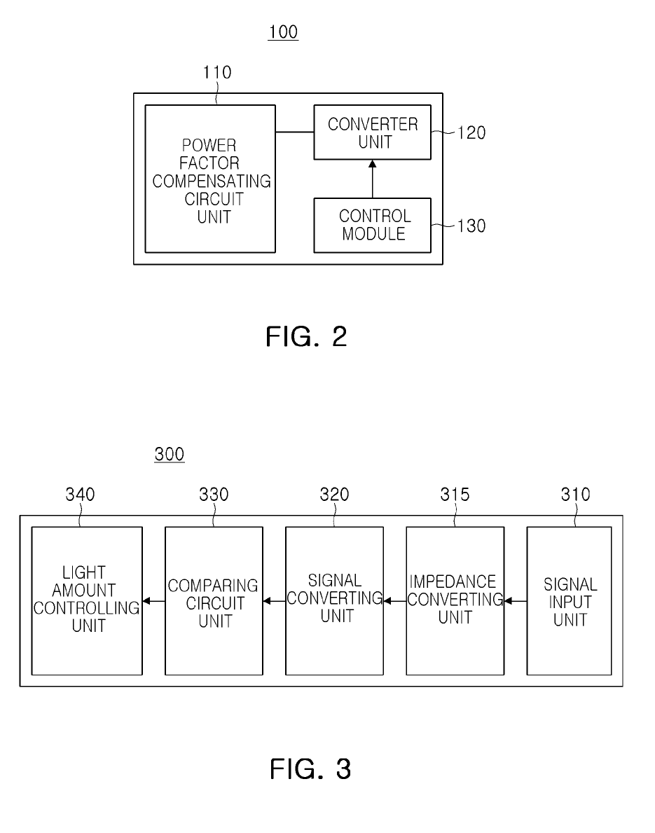

FIG. 2 is a block diagram showing an example of a driving circuit unit 100 shown in FIG. 1.

Referring to FIG. 2, the driving circuit unit 100 may include a power factor compensating circuit unit 110, a converter unit 120, and a control module 130.

The power factor compensating circuit unit 110 may control a power factor of the input power and receive the rectified power from the rectifying unit 600.

The converter unit 120 may convert a voltage level of the input power provided by the power factor compensating circuit and provide the input power of which the voltage level is converted to be appropriate for the LED module 400. In addition, the converter unit 120 may include a switching element and may receive a control signal from a control module 130 to be described below to perform a switching operation, thereby controlling the output of the LED module 400.

FIG. 3 is a block diagram showing an example of a controlling circuit unit 300 shown in FIG. 1.

Referring to FIG. 3, the controlling circuit unit 300 may include a signal input unit 310, a signal converting unit 320, a comparing circuit unit 330, and a light amount controlling unit 340.

In addition, the controlling circuit unit 300 may further include an impedance converting unit 315 positioned between the signal input unit 310 and the signal converting unit 320.

The signal input unit 310 may receive the external signal and provide the external signal to the impedance converting unit 315. That is, the signal input unit 310 may receive the external signal from one of the sensor module 510, the communications module 520, and the output control module 530.

Then, the impedance converting unit 315 may adjust impedance between the signal input unit 310 and the signal converting unit 320. The signal converting unit 320 may convert the external signal into a reference signal. Then, the signal converting unit 320 may provide the reference signal to the comparing circuit unit 330.

The comparing circuit unit 330 may include at least two comparators, each of which may receive the output voltage and the output current provided by the detecting circuit unit 200 as an input. In addition, the at least two comparators may receive the reference signal provided by the signal converting unit 320 as another input.

Then, the comparing circuit unit 330 may compare the received reference signal with at least one of the output voltage and the output current and provide a comparison result to the light amount controlling unit 340.

The light amount controlling unit 340 may control the output of the LED module 400 depending on the comparison result of the comparing circuit unit 330. That is, the light amount controlling unit 340 may generate a control signal depending on the comparison result and provide the generated control signal to the control module 130 of the driving circuit unit 100, and the control module 130 may control the output of the LED module 400 depending on the control signal.

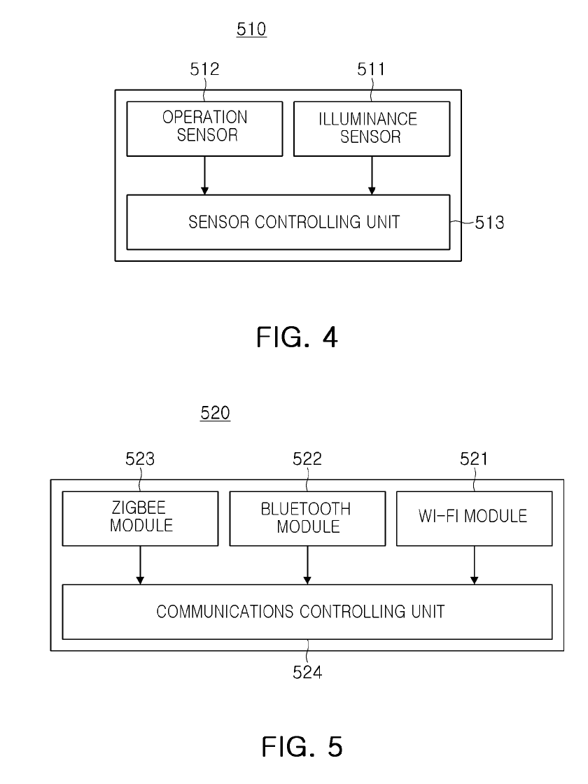

FIG. 4 is a block diagram showing an example of a sensor module 510 shown in FIG. 1.

Referring to FIG. 4, the sensor module 510 may include an illuminance sensor 511 sensing external illuminance, an operation sensor 512 sensing an external operation, and a sensor controlling unit 513. In addition, although not shown, the sensor module 510 may also include a heat sensor sensing external heat.

The illuminance sensor 511 and the operation sensor 512 may provide sensed data to the sensor controlling unit 513, and the sensor controlling unit 513 may generate the first signal using the sensed data provided by at least one of the illuminance sensor 511 and the operation sensor 512. Then, the sensor controlling unit 513 may provide the first signal to the controlling circuit unit 300.

FIG. 5 is a block diagram showing an example of a communications module 520 shown in FIG. 1.

Referring to FIG. 5, the communications module 520 may include a Wi-Fi module 521, a Bluetooth module 522, a Zigbee module 523, and a communications controlling unit 524.

The Wi-Fi module 521 may transmit and receive data to and from the outside using Wi-Fi communications. The Bluetooth module 522 may transmit and receive data to and from the outside using Bluetooth communications, and the Zigbee module 523 may transmit and receive data to and from the outside using Zigbee communications.

Here, the Wi-Fi module 521, the Bluetooth module 522, and the Zigbee module 523 may provide the data provided by the outside to the communications controlling unit 524, and the communications controlling unit 524 may generate the second signal using the data. Then, the communications controlling unit 524 may provide the second signal to the controlling circuit unit 300.

Meanwhile, the output control module 530 may receive the output current provided by the detecting circuit unit 200 and generate the third signal for controlling the switching operation of the switching element of the driving circuit unit 100 depending on the received output current. Here, the third signal may be a pulse width modulation (PWM) signal.

FIG. 6 is a block diagram showing the LED control device of FIG. 1 in more detail.

Next, an operation of the LED control device according to an exemplary embodiment of the present disclosure will be described in detail with reference to FIG. 6.

First, the rectifying unit 600 may rectify the input power, the AC power, and provide the rectified power to the driving circuit unit 100. Then, the driving circuit unit 100 may convert the rectified input power into the output voltage and provide the output voltage to the LED module 400.

Here, the detecting circuit unit 200 may include a voltage detecting unit 210 detecting the output voltage and a current detecting unit 220 detecting the output current of the LED module 400, and the output voltage and the output current detected by the voltage detecting unit 210 and the current detecting unit 220, respectively, may be provided to the comparing circuit unit 330 in the controlling circuit unit 300.

Meanwhile, the signal input unit 310 may receive the external signal for controlling the output of the LED module 400 from one of the sensor module 510, the communications module 520, and the output control module 530.

Here, the sensor controlling unit 513 of the sensor module 510 may receive the sensed data on the external illuminance sensed by the illuminance sensor 511 or the sensed data on whether or not the external operation is present, sensed by the operation sensor 512 and generate the first signal. In addition, the communications module 520 may receive the data through communications with the outside. In this case, each of the Wi-Fi module 521, the Bluetooth module 522, and the Zigbee module 523 may be used depending on a communications method. Then, the communications controlling unit 524 may generate the second signal using the data received through the communications with the outside. Meanwhile, the output control module 530 may generate the third signal, the PWM signal, using the output current of the LED module 400 provided by the detecting circuit unit 200.

That is, the signal input unit 310 may receive one of the first to third signals and provide the received signal to the impedance converting unit 315. Then, the impedance converting unit 315 may adjust the impedance between the signal input unit 310 and the signal converting unit 320.

The signal converting unit 320 may generate the reference signal using the external signal. In other words, the signal converting unit 320 may convert the external signal into the reference signal in order to allow the light amount controlling unit 340 to use the reference signal as reference power for controlling the output of the LED module 400.

The reference signal may be input to the comparing circuit unit 330. The comparing circuit unit 330 may include at least two comparators as an example, and the generated reference signal may be input to each of the at least two comparators. In addition, the output voltage and the output current detected by the detecting circuit unit 200 may also be provided as another input to the at least two comparators.

Then, a comparison result of the comparing circuit unit 330 may be provided to the light amount controlling unit 340, and the light amount controlling unit 340 may control the output voltage and the output current provided to the LED module 400. In this case, the light amount controlling unit 340 may control a magnitude of the output or control a conduction time in a period of the output.

Meanwhile, the controlling circuit unit 300 may change a the driving circuit unit 100 into a standby mode in the case in which a voltage level of the reference signal is a preset voltage or less, as the comparison result of the comparing circuit unit 330. That is, the controlling circuit unit 300 determines whether the voltage level of the reference signal is the preset voltage or less to change the driving circuit unit 100 into the standby mode, whereby power consumption of the driving circuit unit 100 may be significantly decreased.

Meanwhile, the light amount controlling unit 340 may limit a minimum current and a maximum current of the output of the LED module 400 based on the reference signal. Therefore, the LED module 400 may maintain a constant light amount to control a change in a light amount of the LED module 400 depending on dispersion.

In addition, the controlling circuit unit 300 may determine a state of the output of the LED module 400 through the reference signal. That is, in the case in which the output of the LED module 400 is in an abnormal state, the controlling circuit unit 300 may determine that the output of the LED module 400 is in the abnormal state. As an example, in the case in which it is determined that the output of the LED module 400 is in the abnormal state, the controlling circuit unit 300 changes the driving circuit unit 100 into the standby mode, whereby damage to the LED control device may be prevented.

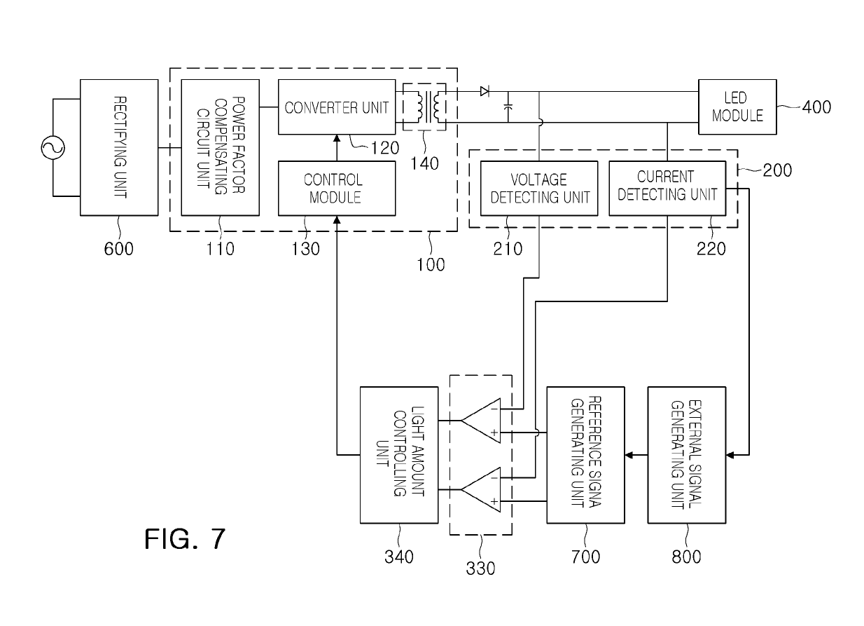

FIG. 7 is a block diagram showing an LED control device according to another exemplary embodiment of the present disclosure.

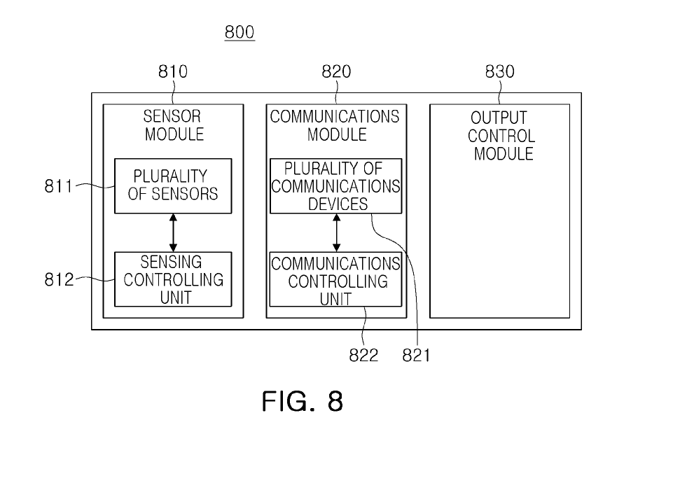

FIG. 8 is a block diagram showing an example of an external signal generating unit 800 shown in FIG. 7.

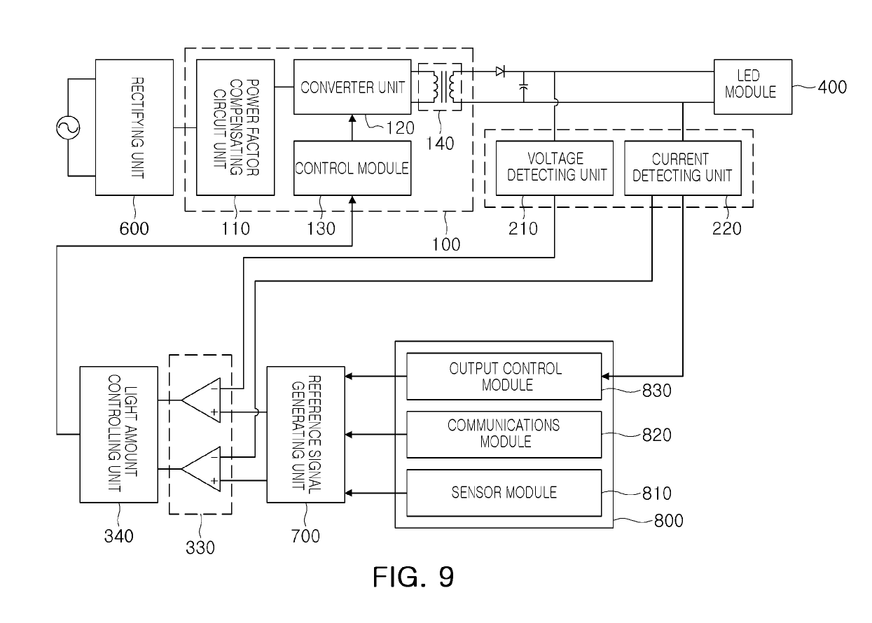

FIG. 9 is a block diagram showing the LED control device of FIG. 7 in more detail.

Referring to FIGS. 7 through 9, an LED control device according to another exemplary embodiment of the present disclosure may include a driving circuit unit 100, a detecting circuit unit 200, a reference signal generating unit 700, a comparing circuit unit 330, a light amount controlling unit 340, and an external signal generating unit 800.

The driving circuit unit 100 may include at least one transformer 140, and may generate an output voltage from input power and provide the output voltage to an LED module 400.

Meanwhile, the detecting circuit unit 200 may be positioned on a secondary side of the transformer 140, and may detect the output voltage and an output current of the LED module 400.

The reference signal generating unit 700 may adjust impedance between the external signal generating unit and the light amount controlling unit. In addition, the reference signal generating unit 700 may then provide a generated reference signal to the comparing circuit unit 330.

The comparing circuit unit 330 may compare the reference signal with at least one of the output voltage and the output current and provide a comparison result to the light amount controlling unit 340.

The light amount controlling unit 340 may control the output of the LED module 400 depending on the comparison result of the comparing circuit unit 330. In addition, the light amount controlling unit 340 may change the driving circuit unit 100 into a standby mode in the case in which a voltage level of the reference signal is a preset voltage or less, as the comparison result of the comparing circuit unit 330.

Meanwhile, the LED control device according to another exemplary embodiment of the present disclosure may further include a rectifying unit 600 positioned on a primary side of the transformer 140, rectifying the input power, and providing the rectified power to the driving circuit unit 100.

In addition, the driving circuit unit 100 may further include a power factor compensating circuit unit 110 positioned at the primary side of the transformer 140 and controlling a power factor of the input power, a converter unit 120 including a switching element, converting a voltage level of the input power provided by the power factor compensating circuit unit 110, and supplying the input power of which the voltage level is converted to be appropriate for the LED module 400, and a control module 130 controlling a switching operation of the switching element.

Referring to FIG. 9, the external signal generating unit 800 among the components of the LED control device according to another exemplary embodiment of the present disclosure may include a sensor module 810, a communications module 820, and an output control module 830.

Meanwhile, since the respective components of the LED control device according to another exemplary embodiment of the present disclosure and operations thereof are the same as the respective components of the LED control device according to an exemplary embodiment of the present disclosure described above and operations thereof, a description thereof will be omitted.

As set forth above, an LED control device according to exemplary embodiments of the present disclosure may actively cope with various control methods and have high convenience by integrating various control modules in a single device.

While exemplary embodiments have been shown and described above, it will be apparent to those skilled in the art that modifications and variations could be made without departing from the spirit and scope of the present disclosure as defined by the appended claims.

What is claimed is:

1. A light emitting diode (LED) controlling device comprising:
a driving circuit unit converting input power into an output voltage and providing the output voltage to an LED module;
a detecting circuit unit positioned between the driving circuit unit and the LED module and detecting the output voltage and an output current of the LED module; and
a controlling circuit unit converting an external signal into a reference signal and comparing the reference signal with at least one of the output voltage and the output current to control an output of the LED module,
wherein the external signal is one of a first signal provided by a sensor module, a second signal provided by a communications module, and a third signal provided by an output control module.

2. The LED control device of claim 1, further comprising a rectifying unit rectifying the input power and providing the rectified power to the driving circuit unit.

3. The LED control device of claim 1, wherein the driving circuit unit includes:
a power factor compensating circuit unit controlling a power factor of the input power;
a converter unit including a switching element, converting a voltage level of the input power provided by the power factor compensating circuit, and providing the input power of which the voltage level is converted to be appropriate for the LED module; and
a control module controlling a switching operation of the switching element of the converter unit.

4. The LED control device of claim 1, wherein the controlling circuit unit includes:
a signal input unit receiving the external signal;
a signal converting unit converting the external signal provided by the signal input unit into the reference signal;
a comparing circuit unit comparing the reference signal with at least one of the output voltage and the output current; and
a light amount controlling unit controlling the output of the LED module depending on a comparison result of the comparing circuit unit.

5. The LED control device of claim 4, wherein the controlling circuit unit further includes an impedance converting unit adjusting impedance between the signal input unit and the signal converting unit.

6. The LED control device of claim 1, wherein the sensor module includes:
an illuminance sensor sensing external illuminance;
an operation sensor sensing an external operation; and
a sensor controlling unit generating the first signal using sensed data provided by at least one of the illuminance sensor and the operation sensor and providing the first signal to the controlling circuit unit.

7. The LED control device of claim 1, wherein the communications module includes:
a Wi-Fi module transmitting and receiving data to and from the outside using Wi-Fi communications;
a Bluetooth module transmitting and receiving data to and from the outside using Bluetooth communications;
a Zigbee module transmitting and receiving data to and from the outside using Zigbee communications; and
a communications controlling unit generating the second signal using the data provided by at least one of the Wi-Fi module, the Bluetooth module, and the Zigbee module and providing the second signal to the controlling circuit unit.

8. The LED control device of claim 3, wherein the output control module generates the third signal for controlling the switching operation of the switching element and provides the third signal to the controlling circuit unit, the third signal being a pulse width modulation (PWM) signal.

9. The LED control device of claim 1, wherein the controlling circuit unit changes the driving circuit unit into a standby mode in the case in which a voltage level of the reference signal is a preset voltage or less.

10. An LED control device comprising:
a driving circuit unit including a transformer, generating an output voltage from input power, and providing the output voltage to an LED module;
a detecting circuit unit positioned on a secondary side of the transformer and detecting the output voltage and an output current of the LED module;
a reference signal generating unit receiving an external signal and generating a reference signal;
a comparing circuit unit comparing the reference signal with at least one of the output voltage and the output current; and
a light amount controlling unit controlling an output of the LED module depending on a comparison result of the comparing circuit unit.

11. The LED control device of claim 10, further comprising a rectifying unit positioned on a primary side of the transformer, rectifying the input power, and providing the rectified power to the driving circuit unit.

12. The LED control device of claim 10, wherein the driving circuit unit includes:
a power factor compensating circuit unit positioned on a primary side of the transformer and controlling a power factor of the input power;
a control module controlling a switching operation of a switching element included in the primary side of the transformer; and
a converter unit converting a voltage level of the input power provided by the power factor compensating circuit unit and supplying the input power of which the voltage level is converted to be appropriate for the LED module.

13. The LED control device of claim 10, further comprising an external signal generating unit generating the external signal using at least one of a sensor module, a communications module, and an output control module,
wherein the sensor module includes a plurality of sensors and a sensing controlling unit generating a first signal using sensed data provided by the plurality of sensors,
the communications module includes a plurality of communications devices and a communications controlling unit generating a second signal using communications data provided by the plurality of communications devices,
the output control module generates a third signal for controlling a switching operation of a switching element included in a primary side of the transformer depending on the output current provided by the detecting circuit unit, and
the external signal is one of the first to third signal.

14. The LED control device of claim 13, wherein the third signal is a PWM signal.

15. The LED control device of claim 13, wherein the plurality of sensors include at least one of an illuminance sensor sensing external illuminance and providing illuminance data to the sensing controlling unit, a heat sensor sensing external heat and providing heat data to the sensing controlling unit, and an operation sensor sensing an external operation and providing operation data to the sensing controlling unit.

16. The LED control device of claim 13, wherein the plurality of communications devices include at least one of a Wi-Fi module providing data received from the outside using Wi-Fi communications to the communications controlling unit, a Bluetooth module providing data received from the outside to the communications controlling unit using Bluetooth communications, and a Zigbee module providing data received from the outside to the communications controlling unit using Zigbee communications.

17. The LED control device of claim 13, wherein the reference signal generating unit adjusts impedance between the external signal generating unit and the light amount controlling unit.

18. The LED control device of claim 13, wherein the light amount controlling unit changes the driving circuit unit into a standby mode in the case in which a voltage level of the reference signal is a preset voltage or less, as the comparison result of the comparing circuit unit.
